(19) United States
(12) Patent Application Publication
(10) Pub. No.: US 2008/0225377 A1
(43) Pub. Date: Sep. 18, 2008

(54) Bi-Directional Optoelectric Conversion

(75) Inventor: Josef Beller, Tuebingen (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies., Inc.

(21) Appl. No.: 10/585,771

(22) PCT Filed: Mar. 8, 2004
(86) PCT No.: PCT/EP2004/050267

§ 371 Date: Jul. 12, 2006

(51) Int. Cl. G02F 1/29

(52) U.S. Cl. 359/315

(57) ABSTRACT

An apparatus and to a method of optoelectrical conversion, comprising the steps of: providing a first electrical signal to an electrical directional element, using the electrical directional element to direct the first electrical signal to an optoelectric converter, using the optoelectric converter for converting the first electrical signal into an optical signal and providing the optical signal to a DUT, using the optoelectric converter for receiving and converting a reflected optical signal reflected by the DUT back into a second electrical signal, and using the electrical directional element to direct the second electrical signal to a receiver.

### BACKGROUND OF THE INVENTION

The present invention relates to optoelectric conversion in a system with bi-directional signal transmission.

Optoelectric conversion is of particular interest for optical measurements, e.g. for optical time domain reflectometry (OTDR) measurements. In the context of this application, optoelectric conversion means any conversion of an electrical signal into an optical signal and/or of an optical signal into an electrical signal. OTDR usually probes a device under test (DUT) with a laser pulse and displays the DUTs response as a power vs. distance graph. A detailed technical description about the state of the art of OTDR measurements is given by Dennis Derickson in “Fiber Optic Test and Measurement Handbook, Chapter 11, by Prentice-Hall Inc., Upper Saddle River, N.J. 07458, USA, 1998”. When performing OTDR an electrical signal has to be transformed into an optical signal, e.g. the laser pulse, and the DUTs response, i.e., the reflected optical signal has to be converted back into an electrical signal.

FIG. 1 shows a schematic illustration of an OTDR setup of the prior art. According to FIG. 1 a transmitter driver 101 establishes an electrical signal driving a transmitting device 103. Consequently, the transmitting device 103 is acting as an optoelectric converting device and transforms the electrical signal into an optical signal and emits the optical signal which is provided to an optical directional device 105. The optical directional device 105 directs the optical signal into an optical fiber 106. The optical fiber 106 is the optical front end of the displayed OTDR setup and provides the connection to a DUT, e.g. a fiber under test (not shown).

The optical signal reflected by the DUT (not shown) is then provided by the fiber 106 back to the optical directional device 105. The optical directional device 105 provides the reflected optical signal to a receiving device 104 acting as another optoelectric converter, which converts the reflected optical signal back into an electrical signal. The electrical signal is then provided to a receiver 102 as an evaluation unit for the OTDR measurement.

### SUMMARY OF THE INVENTION

It is an object of the invention to improve optoelectric conversion.

The object is solved by the independent claims.

In systems with bidirectional signal transmission or exchange, at least one terminal or communication end comprises a source or signal transmitting part and a drain or a signal receiving part if the signals are transmitted over one unique transmission medium; e.g. in both directions of a transmission line connecting two or more communication terminals, the signals destined to the bi-directional end have to be properly directed to the receiving part. Therefore, a directional element is provided between this terminal and the transmission medium.

In optoelectrical systems, at least one terminal works on an electrical level sending or receiving electrical signals and at least one terminal works on an optical level sending or receiving optical signals. For passing signals between the optical terminal and the electrical terminal, an optoelectric converter is provided somewhere between those ends in order to convert a corresponding electrical signal into an optical signal or vice versa.

In optoelectrical systems with bidirectional signal transmission, conversion needs to be performed in both directions. According to the present invention an electrical directional element is provided on the transmitting and receiving part on the electrical side of the setup instead of implementing an optical directional element (e.g. an optical splitter) on the optical side of the setup.

The electrical transmitter in such a setup sends a first electrical signal to an electrical directional element. The electrical directional element directs the first electrical signal to an optoelectric converter for converting the first electrical signal into an optical signal and providing the optical signal to an optical device, e.g. a device Under Test (DUT). An optical signal returning from the optical device is received by the optoelectric converter converting back the received optical signal into a second electrical signal and passing this signal to the electrical directional element. The directional element directs the second electrical signal to an electrical receiver.

An advantage of an embodiment of the present invention is that a reduced number of elements is needed and especially a reduced number of optoelectric converters is needed compared to splitting the receiving and transmitting path in the optical domain, because optoelectric conversion is effected by only one element for both directions. The inventive setup is simpler, smaller, needs less manufacturing steps, reduces cost and improves reliability of the measurement equipment.

Preferably, the optoelectric converter is converting the first electrical signal into an optical signal by emitting light caused by an electrical excitation of the optoelectric converter by the first electrical signal.

The optoelectric converter preferably converts the reflected optical signal back into a second electrical signal by generating an electrical signal caused by an optical excitation of the optoelectric converter by the optical signal.

In a further embodiment, a time delay is introduced between the optical signal to the DUT and receiving the reflected optical signal from the DUT. Therefore, a time delay element is connected to the optoelectric converter and the DUT.

In a further embodiment, the electrical directional element comprises a switch for switching the electrical part of optoelectric converter either to the electrical transmitter or to the electrical receiver.

Preferably the optoelectric converter comprises a laser diode and/or a light emitting diode.

In a further embodiment, a transmitter driver of the electrical sender and the electrical receiver form parts of an evaluation unit for an OTDR measurement setup.

The invention can be partly embodied or supported by one or more suitable software programs, which can be stored on or otherwise provided by any kind of data carrier, and which might be executed in or by any suitable data processing unit Software programs or routines are preferably applied to the realization of the inventive method.

Other aspects and advantages of the present invention will become apparent from the following detailed description and the accompanying drawings.

### BRIEF DESCRIPTION OF THE DRAWINGS

Other objects and many of the attendant advantages of the present invention will be readily appreciated and become better understood by reference to the following detailed description when considering in connection with the accompanied drawings. The components in the drawings are not necessarily to scale, emphasis instead being placed upon clearly illustrating the principles of the present invention. Features that are substantially or functionally equal or similar will be referred to with the same reference sign(s).

FIG. 1 shows a schematic illustration of an OTDR setup of the prior art as described above, and

FIG. 2 and 3 show schematic illustrations of embodiments of the present invention.

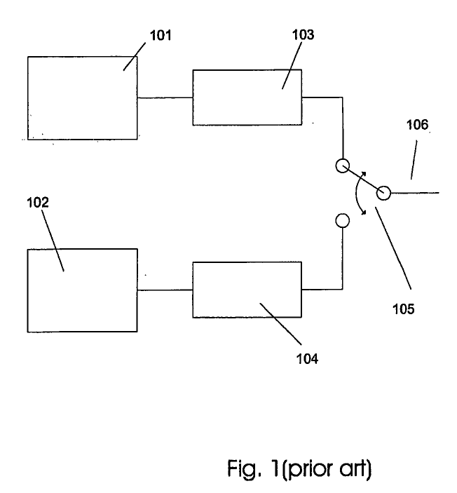

### DETAILED DESCRIPTION OF PREFERRED EMBODIMENTS OF THE INVENTION

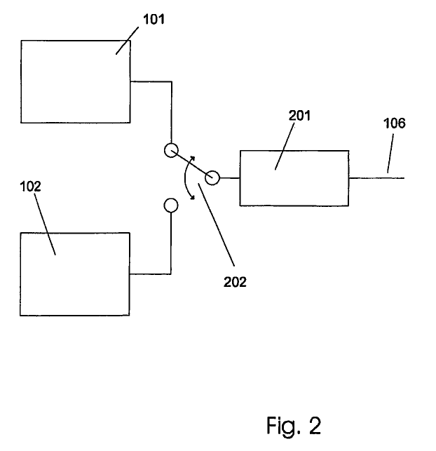

Referring now in greater detail to the drawings, FIG. 2 shows a schematic illustration of an OTDR setup according to a first embodiment of the present invention.

The setup of FIG. 2 comprises a transmitter driver 101 to establish an electrical signal which is provided to an electrical switch 202 as an electrical directional element. Alternatively, a bidirectional electrical path (not shown) can be used as the electrical directional element. The electrical switch 202 provides the electrical signal to an optoelectric converter 201. The optoelectric converter 201 is acting as an optoelectric converting device and transforms the electrical signal into an optical signal and emits the optical signal which is provided to an optical fiber 106. The optical fiber 106 is the optical front end of the displayed OTDR setup and provides the connection to a DUT (not shown), e.g. a fiber under test (not shown). However, alternatively the optical fiber 106 can also be the DUT. The optoelectric converter 201 can comprise a laser diode or a light emitting diode (LED).

The optical signal reflected by the DUT (not shown) is then provided by the fiber 106 back to the optoelectric converter 201. The optoelectric converter 201 converts the reflected optical signal back into an electrical signal. The optoelectric converter 201 is therefore acting as a combined emitting and receiving device for optical signals. The electrical signal is then provided to an electrical switch 202 as an electrical directional element. In the meantime, according to the two head arrow in FIG. 2, the electrical switch 202 has switched from the upper connection connecting the transmitter driver 101 with the optoelectric converter 201 to the lower connection connecting the optoelectric converter 201 with a receiver 102 as an evaluation unit for the OTDR measurement. Accordingly, the electrical signal is then provided to the receiver 102.

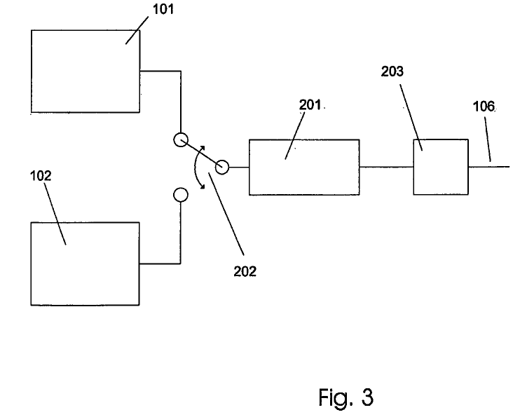

FIG. 3 shows a schematic illustration of an OTDR setup according to a second embodiment of the present invention. According to this embodiment a time delay element 203, e.g. an additional delay fiber (not shown), is added between the optoelectric converter 201 and the fiber 106. The time delay element 203 introduces a time delay between the emitted optical signal and the received optical signal. The time delay serves to provide the optoelectric converter 201 with time to switch from its transmitting state into its receiving state, e.g. to switch its transmitting circuit into its receiving circuit.

1. A method of optoelectrical conversion, comprising the steps of:
providing a first electrical signal to an electrical directional element (202),
the electrical directional element (202) directing the first electrical signal s to an optoelectric converter (201),
the optoelectric converter (201) converting the first electrical signal into an optical signal and providing the optical signal to a DUT (106),
the optoelectric converter (201) receiving and converting a reflected optical signal reflected by the DUT (106) back into a second electrical signal, and
the electrical directional element (202) directing the second electrical signal to a receiver (102).

2. The method of claim 1, further comprising the steps of:
the optoelectric converter (201) converting the first electrical signal into an optical signal by emitting light caused by an electrical excitation of the optoelectric converter (201) by the first electrical signal.

3. The method of claim 1 or any one of the above claims, further comprising the steps of:
the optoelectric converter (201) converting the reflected optical signal back into a second electrical signal by generating an electrical signal caused by an optical excitation of the optoelectric converter (201) by the optical signal.

4. The method of claim 1 or any one of the above claims, further comprising the steps of:
introducing a time delay between providing the optical signal to the DUT (106) and receiving the reflected optical signal from the DUT (108).

5. A method of performing an OTDR measurement by using the method of claim 1 or any one of the above claims.

6. A software program or product, preferably stored on a data carrier, for executing the method of one of the claims 1 to 5 when run on a data processing system such as a computer.

7. An apparatus for optoelectrical conversion, comprising:
a transmitter driver (101) for providing a first electrical signal to an electrical directional element (202) connected to the transmitter driver the electrical directional element (202) for directing the first electrical signal to an optoelectric converter (201) connected to the electrical directional element (202),
the optoelectric converter (201)
for converting the first electrical signal into an optical signal and for providing the optical signal to a DUT (106) connected to the optoelectric converter (201), and
for receiving and converting a reflected optical signal reflected by the DUT (106) back into a second electrical signal, and
a receiver (102) for receiving the second electrical signal from the electrical directional element (202) connected to the receiver (102).

8. The apparatus of claim 7,
wherein the transmitter driver (101) comprises a laser driver.

9. The apparatus of claim 7 or any one of the above claims,
wherein the electrical directional element (202) comprises a switch to switch between a connection of the transmitter driver (101) with the optoelectric converter (201) and of the receiver (102) with the optoelectric converter (201).

10. The apparatus of claim 7 or any one of the above claims,
wherein the electrical directional element (202) comprises an electrical directional coupling device.

11. The apparatus of claim 7 or any one of the above claims,
wherein the optoelectric converter (201) comprises a laser diode and/or a light emitting diode.

12. The apparatus of claim 7 or any one of the above claims, further comprising:
wherein the transmitter driver (101) and the receiver (102) are part of an evaluation unit for a OTDR measurement setup.

13. The apparatus of claim 13 or any one of the above claims, further comprising:
a time delay element (203) connected to the optoelectric converter (201) and the DUT (106) for introducing a time delay between the provision of the optical signal to the DUT (106) and the receipt of the reflected optical signal from the DUT (106) by the optoelectric converter (201).

14. An OTDR measurement setup comprising an apparatus of claim 7 or any one of the above claims.
